(19) United States
(12) Patent Application Publication
(10) Pub. No.: US 2024/0412223 A1
(43) Pub. Date: Dec. 12, 2024

(54) CONFIGURABLE SERVICES FOR A PAYMENT INSTRUMENT

(71) Applicant: American Express Travel Related Services Company, Inc., New York, NY (US)

(72) Inventors: Rajendra P. Modadugu, Weston, FL (US); Jyothsna Nayak, Weston, FL (US)

(21) Appl. No.: 18/331,512

(22) Filed: Jun. 8, 2023

(51) Int. Cl. G06Q 20/40; G06Q 20/34; G06Q 20/38

(52) U.S. Cl. CPC G06Q 20/405; G06Q 20/355; G06Q 20/3821

(57) ABSTRACT

Systems and methods are described relating to a payment instrument with configurable services, in which the user can adjust the available services. In one example, a system includes a computing device that is configured to display a user interface that is configured to modify a services configuration for a payment instrument. The services configuration indicates a plurality of benefit services that are applied to a respective transaction. A modification of the services configuration is received from the user interface. An updated user interface is displayed that includes a charge for the services configuration based at least in part on the modification of the services configuration. An acceptance of the charge is received from the updated user interface. The services configuration is updated by storing the services configuration in association with the user identifier at a database based at least in part on the acceptance of the charge.

### BACKGROUND

Financial institutions provide payment instruments (e.g., credit cards, debit cards, charge cards, gift cards, etc.) that offer a variety of fixed services. In some instances, a user may have a first payment instrument because it offers a variety of travel related services, and the user may have a second payment instrument because it offers a variety of cash back related services. While having multiple payment instruments, the user may want to know which payment instrument to use for a particular transaction based on the transaction type and a desired service that the user is seeking.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a services user interface displayed on a client device according to various embodiments of the present disclosure.

FIG. 2 is a drawing of a network environment according to various embodiments of the present disclosure.

FIG. 3 is another drawing of a services user interface displayed on a client device pictorial diagram of an example user interface rendered by a client in the network environment of FIG. 2 according to various embodiments of the present disclosure.

FIG. 4 includes illustrations of example data structures that can be implemented as portions of the computing environment in the network environment of FIG. 2 according to various embodiments of the present disclosure.

FIG. 5 is a flowchart illustrating one example of functionality implemented as portions of an application executed in a client device in the network environment of FIG. 2 according to various embodiments of the present disclosure.

FIG. 6 is a flowchart illustrating one example of functionality implemented as portions of an application executed in a computing environment in the network environment of FIG. 2 according to various embodiments of the present disclosure.

FIG. 7 is a flowchart illustrating one example of functionality implemented as portions of an application executed in a computing environment in the network environment of FIG. 2 according to various embodiments of the present disclosure.

### DETAILED DESCRIPTION

The present disclosure relates to a payment instrument with configurable services, in which the user can adjust the services for the payment instrument over time. Typically, financial institutions provide payment instruments (e.g., credit cards, debit cards, charge cards, gift cards, etc.) that offer a variety of fixed services. In some instances, a user may have a first payment instrument because it offers a variety of travel related services (e.g., travel reward points, travel priority status, discounted travel fees, etc.), and the user may have a second payment instrument because it offers a variety of cash back related services (e.g., a percentage of cash back on certain purchases). While having multiple payment instruments, the user may determine which payment instrument to use for a particular transaction based on the present transaction type.

Multiple problems are presented with this approach for the user and financial institutions. For example, the user may have to carry multiple payment instruments with them in order to have the capability to use a variety of different payment instruments. Users may find it cumbersome to carry several payment instruments in a wallet or purse because of the space multiple payment instruments occupy in a wallet or purse. For example, some wallets (e.g., a pocket wallet, a foldable wallet, a travel wallet, etc.) may be restricted in the quantity of payment instruments it can physically hold.

Also, manufacturers may pay significant costs for onboarding and maintaining each additional payment instrument of the user. For example, luxury or premium payment cards manufacture from exotic materials can be costly. There is also a cost associated with manufacturing and replace lost or stolen payments cards. Additionally, there are ongoing costs associated with an open account, such as fraud monitoring and prevention services provided to existing customers.

To address these issues, various embodiments of the present disclosure introduce a payment instrument with configurable services. The configurable payment instrument can allow the user to adjust a list of services available for use with the configurable payment instrument. For example, the user can select, on a client device, a first set of services to be available for use when the configurable payment instrument is used for completing a transaction. At some future point in time, the user can configure a second set of services to be available for use with the payment instrument for transactions. The second set of services could replace the first set of services or supplement the existing first set of services (e.g., in exchange for a fee). Some non-limiting examples of services that can be configured and modified by the user of the payment instrument can include 1) one or more benefit services (e.g., reward point accumulation, types of rewards points accumulated, rates at which rewards points are accumulated, etc.) 2) fraud monitoring services (e.g., selecting different tiers of fraud monitoring services, selecting types of fraud monitoring services, etc.) 3) financial services (e.g., annual percentage rates for financing and annual operating fees for the payment instrument, etc.), and liability services (e.g., different tiers of liability coverage), and other suitable types of payment instrument services.

The embodiments may be capable of achieving certain advantages. For example, the embodiments can improve the functionality of a payment instrument by allowing users to configure and modify which services that can be used for a transaction. Also, the embodiments can improve the functionality of computer systems and networks by providing a user interface that allows users to configure the available services that are applicable to a payment instrument. Additionally, the embodiments can constitute an improvement in the field because the embodiments reduce the quantity of payment instruments that a user would physically carry on their person. Further, the embodiments can improve the functionality (e.g., speed and configurability) of computer systems and networks in a payment processing environment by using a data structure that enables for the configurability of payment instruments. In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

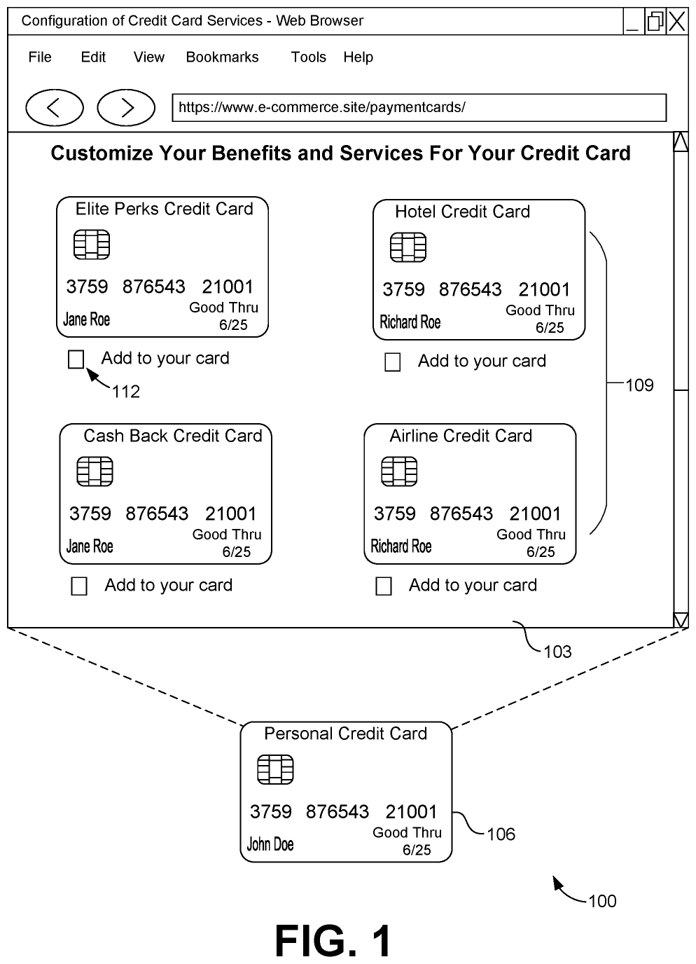

Referring now to FIG. 1, shown is a drawing of one example scenario 100 of a services user interface 103 according to various embodiments of the present disclosure. In FIG. 1, a user is interacting with the services user interface 103 to configure or modify a list of services for a payment instrument 106 of the user. For example, the user can use the services user interface 103 to add or remove one or more services to be applicable to the payment instrument 106.

As shown in the non-limiting example of FIG. 1, the user has an existing payment instrument 106 and the services user interface 103 displays an array of other supplemental payment instruments 109 with different services from the existing payment instrument 106. The user can select one or more of the supplemental payment instruments 109 to add the services associated with the supplemental payment instruments 109 to the existing payment instrument 106. As such, the user can, via the services user interface 103, create a hybrid list of services for the exiting payment instrument 106. The hybrid list of services can include a combination of a first set of services from the existing payment instrument 106 and a second set of services from the supplemental payment instrument 109. Accordingly, the user can use the existing payment instrument 106 and still take advantage of various services that are of interest without having to carry a second or third payment instrument.

In FIG. 1, the services user interface 103 includes an array of supplemental payment instruments 109. Each supplemental payment instrument 109 can represent a unique payment instrument (e.g., credit card, debit card, charge card, rewards card, gift card, etc.) that has unique services. Each supplemental payment instrument 109 can be selected through one or more user interface elements 112. In FIG. 1, the user can click on a user interface element 112 associated with the desired supplemental payment instrument 109.

After the user makes a selection, the services user interface 103 can update to provide a review of the hybrid list of services and if a charge fee would be added in order to implement the hybrid list of services for the payment instrument 106. The user can select to approve of the hybrid list of services from the services user interface 103, which will cause the implementation of the hybrid list of services for subsequent transactions.

For example, in a first scenario, a user may have a personal credit card as an existing payment instrument 106. The personal credit card may have a first set of services, such as one percent (1%) cash back on everyday purchases (e.g., purchases at gas stations, purchases at grocery stores, etc.) and no annual fees. The user may desire to select an Airline Credit Card from the services user interface 103 because the user may be interested in having accumulating airline travel rewards, in which the user is able to earn 2 airline miles reward credit for every one U.S. Dollar ($1 USD) in airline purchases. The user may anticipate making several airfare purchases over the next year. As a result, the user may select the user interface element 112 associated with the Airline Credit Card on the services user interface 103.

Subsequently, the services user interface 103 can be updated to display a hybrid list of services that includes double airline miles reward from the Airline Credit Card and the 1% cash back service from the personal credit card. The updated services user interface 103 can also display a charge fee for adding the airline services to the personal credit card. After reviewing the fee, the user can click or select a user interface element for accepting the hybrid list of services and the charge fee.

In a second scenario, a user can select one or more individual services associated with a particular supplemental payment instrument 109 from the service user interface. For example, a user can select a particular supplemental payment instrument 109 from the services user interface 103 and an updated services user interface 103 can display a list of services for the particular supplemental payment instrument 109 selected. The user can select one or more of list of services to be added to the existing payment instrument. Further, the user can select to remove one or more services from the existing payment instrument 106.

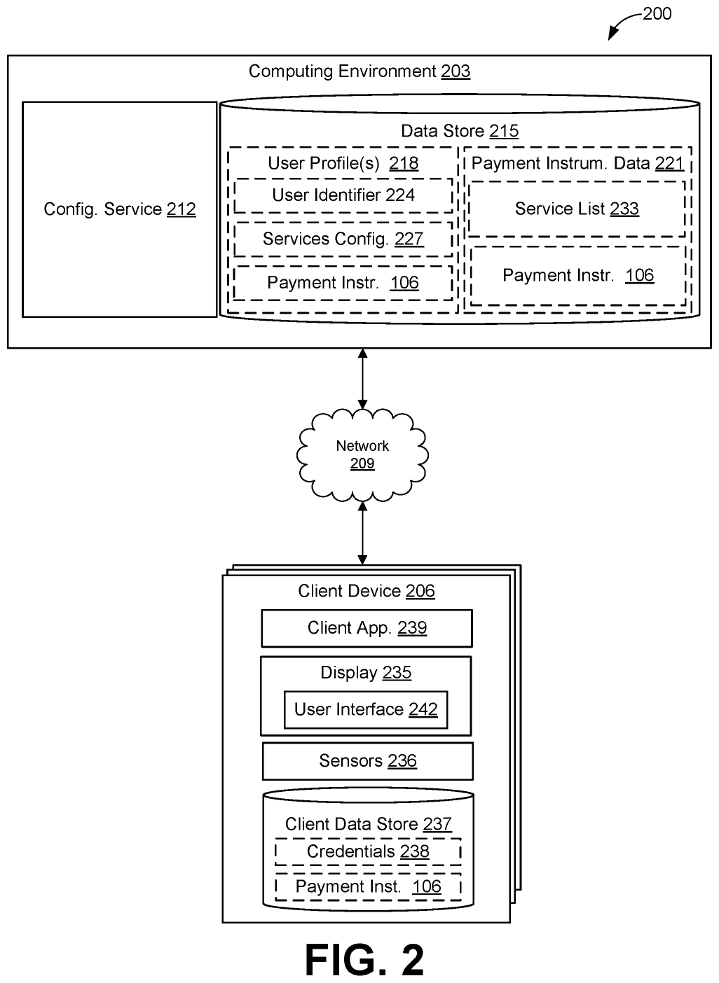

With reference to FIG. 2, shown is a network environment 200 according to various embodiments. The network environment 200 can include a computing environment 203, and a client device 206, which can be in data communication with each other via a network 209.

The network 209 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 209 can also include a combination of two or more networks 209. Examples of networks 209 can include the Internet, intranets, extranets, virtual private networks (VPNs), and similar networks.

The computing environment 203 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203. The components executed on the computing environment 203 can include a configuration service 212, and other applications, services, processes, systems, engines, or functionality not discussed in detail herein.

The configuration service 212 can be executed to configure and modify a list of services for a payment instrument 106. In some embodiments, the configuration service 212 can be executed to generate and display user interfaces on the client device 206 related to the configuration of services for a payment instrument 106.

Also, various data is stored in a data store 215 that is accessible to the computing environment 203. The data store 215 can be representative of a plurality of data stores 215, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 215 is associated with the operation of the various applications or functional entities described below. This data can include user profiles 218, the payment instruments data 221, and potentially other data.

The user profile 218 can represent a user account or a profile for each individual user. In some examples, the user profiles 218 can be the accounts at a financial institution. The user profile 218 can include a user identifier 224, a services configuration 227, a payment instrument 106, and other suitable user profile data elements.

The user identifier 224 can represent a unique identifier for each user profile 218. The services configuration 227 can represent a list of services or benefits that are configured for each payment instrument 106. The configuration service 212 can configure or modify the list of services for each payment instrument 106. Accordingly, the list of services can be configured to be a hybrid of services from two or more payment instruments 106. For example, each payment instrument 106 can start with a default set of services. By way of the services user interface 103, the user can select one or more supplemental payment instruments 109 to combine with the payment instrument 106. Accordingly, a first of services for the existing payment instrument 106 can be combined with a second set of services for the selected supplemental payment instrument 109.

The payment instrument 106 can represent a financial instrument that enables a user to execute a purchase at a point-of-sale (POS) device or online. The payment instrument 106 can include a unique identifier. In some examples, the payment instrument identifier can be a financial account number, a token reference number, and other suitable identifiers.

The payment instrument data 221 can represent data associated with the payment instruments 106. The payment instrument data 221 can include the payment instrument 106 and the service lists 233. The service lists 233 can represent a list of services that have been configured for the payment instrument 106. The payment instrument data 221 can also include one or more weightage-based rules for determining an additional fee for adding one or more services to a payment instrument 106. The weightage-based rules can be one or more rules used to determine an additional charge fee for one or more additional services for the payment instrument 106.

In some instances, a weightage-based rule can be based at least in part on a period of time remaining in a calendar year and/or a specified weighted fee associated with one or more of the specified services. For example, a triple airlines reward points per an airline transaction amount feature may have a first specified weighted fee that is higher than a second specified weighted fee for a double rewards points per an airline transaction amount feature.

The client device 206 is representative of a plurality of client devices that can be coupled to the network 209. The client device 206 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 206 can include one or more displays 235, such as liquid crystal displays (LCDs), gas plasma-based flat panel displays, organic light emitting diode (OLED) displays, electrophoretic ink (“E-ink”) displays, projectors, or other types of display devices. In some instances, the display 235 can be a component of the client device 206 or can be connected to the client device 206 through a wired or wireless connection. The client device 206 can also include one or more sensors 236, such as a location detection unit, accelerometer, or other suitable sensors 236.

In some examples, one or more of the sensors 236 can be used for determining which supplemental payment instruments 109 are available for display on the client device 206 based on the location of the client device 206. Additionally, in some examples, the sensor 236 can be used for dynamically determining the layout of the user interfaces 242 rendered on the display 235. For instance, text and/or graphics relocated based at least in part on a detected orientation (e.g., portrait or landscape) of the display 235 on the client device 206. The text and graphics can be dynamically relocated based on detected gestures (via a touchscreen display) on the display 235. The text and graphics can be dynamically relocated in order to create viewable area in the display 235 for other related text and/or graphics. Certain images or graphics may be omitted or included based on the screen size for the client device 206.

Also, various data is stored in a client data store 237 that is accessible to the client device 206. The data stored in the client data store 237 is associated with the operation of the various applications or functional entities described below. This data can include credentials 238, the payment instrument 106, and potentially other data. The credentials 238 can include data for authenticating the client device 206 with the computing environment 203. Some examples of credentials 238 can include a password, tokens, a session key, and other suitable credential data.

Additionally, the client device 206 can be configured to execute various applications such as a client application 239 or other applications. The client application 239 can be executed to interface with the configuration service 212. The client application 239 can be used to display user interfaces for the configuration service 212 and provide data to the configuration service 212 related to the configuration of services for one or more payment instruments 106.

The client application 239 can also be executed in a client device 206 to access network content served up by the computing environment 203 or other servers, thereby rendering a user interface 242 on the display 235. To this end, the client application 239 can include a browser, a dedicated application, or another executable, and the user interface 242 can include a network page, an application screen, or another user mechanism for obtaining user input. The client device 206 can be configured to execute applications beyond the client application 239 such as email applications, social networking applications, word processors, spreadsheets, or other applications.

Next, a general description of the operation of the various components of the network environment 200 is provided. Although the following description provides an example of the interactions between the various components of the network environment 200, other interactions between the components of the network environment 200 are also encompassed by the various embodiments of the present disclosure.

To begin, a user can have a payment instrument 106 that was provided by a financial institution. The user can login to the site at the financial institution by providing a credential 238. The configuration services 212 can display a user interface 242 on the client device 206 and the user interface 242 can include a “Modify” user interface element for customizing benefits and/or services for the payment instrument 106 of the user.

Upon selection of the user interface element, the configuration services 212 can display a services user interface 103 on the client device 206. The user can select one or more supplemental payment instruments 109 from the services user interface 103. The user may desire to select the one or more supplemental payment instruments 109 based on the services or benefits offered.

Subsequently, the configuration services 212 can display an updated user interface 242 that can include a hybrid list of services that are proposed for the user. The hybrid list of services can include some services from the existing payment instrument 106 and some services from the supplemental payment instrument 109. In some examples, the user can edit the hybrid list of services by adding or removing services from the updated services user interface 103. As services are edited, a fee component displayed for the hybrid list of services will be dynamically updated to correspond to the present selection of services.

After the user approves of the hybrid list of services, the configuration services 212 can store the hybrid list of services as a services configuration 227 for the payment instrument 106 in the data store 215. Accordingly, the services configuration 227 will be retrieved for the next transaction that is completed when using the payment instrument 106.

For example, when an authentication request is received by the configuration service 212. The configuration service 212 can retrieve the services configuration 227 from the data store 215. The services configuration 227 can be retrieved via a data structure that allows for the user to retrieve the hybrid list of services for the payment instrument 106. The data structure can be an improved format for processing, retrieving, and storing data related to the hybrid list of services.

In some examples, after retrieving the hybrid list of services (e.g., the services configuration 227) and receiving an indication of the approval of the transaction, the configuration service 212 can implement one or more services from the hybrid list of services. For instance, the hybrid list of services can include a first service for generating double rewards points for every dollar purchase for travel expenses. A second service can be triple rewards points on restaurant purchases. The configuration services 212 can determine whether one or more of these services apply to the approved transaction.

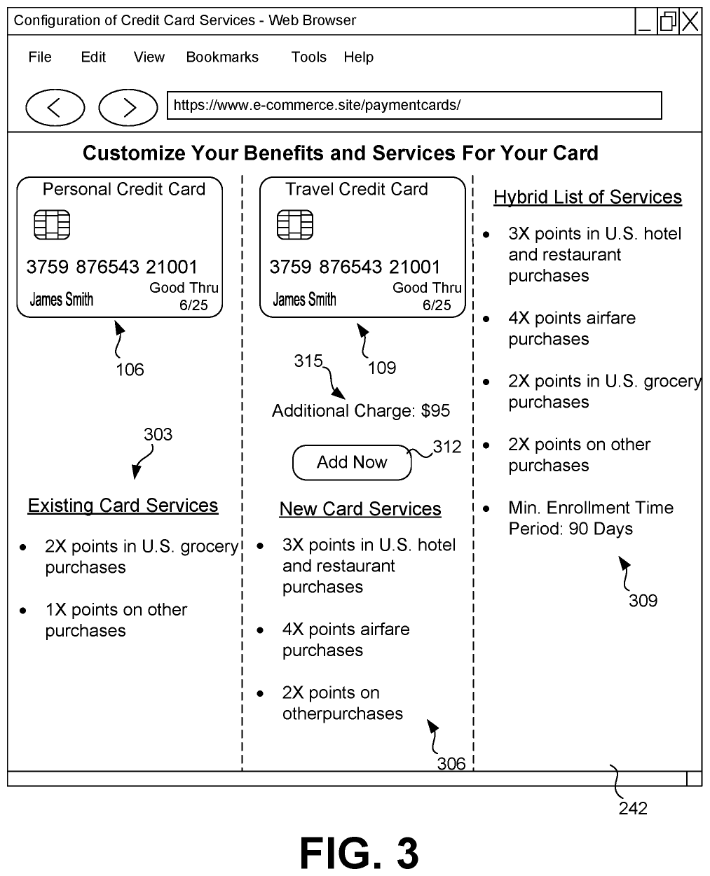

Referring next to FIG. 3, shown is a non-limiting example of an updated user interface 242 for configuring a services configuration 227 for a payment instrument 106. It can be assumed that the user interface 242 is shown after a user has selected a supplemental payment instrument 109 to add to a payment instrument 106. As such, the user interface 242 in FIG. 3 can represent an updated services user interface. FIG. 3 illustrates an overview of a first service lists 233 for the payment instrument 106 and a second service lists 233 for the supplemental payment instrument 109 that has been selected.

As shown in FIG. 3, the user interface 242 includes a first portion 303 for the payment instrument 106, a second portion 306 for the supplemental payment instrument 109, a third portion 309 for a hybrid configuration of services from a combination of the payment instrument 106 and the supplemental payment instrument 109, and other suitable elements.

The first portion 303 for the payment instrument 106 can be generated and displayed from retrieving the user profile 218 of the user. The first portion 303 can include a visual representation of the payment instrument 106. The user profile 218 can include the payment instrument 106 and data related to the payment instrument 106. Some non-limiting examples of the data can include a first service list 233 (e.g., a list of reward services, a list of fraud monitoring services, a list of liability protection, a list of concierge services, etc.). In FIG. 3, the payment instrument 106 is a personal credit card and the first portion 303 includes a list of reward points services associated with the personal credit card (e.g., double rewards points in the U.S. for grocery purchases).

The second portion 306 for the supplemental payment instrument 109 can be generated and displayed from retrieving payment instrument data 221 for the supplemental payment instrument 109. The second portion 306 can include a visual representation of the payment instrument 106. The second portion 306 can identify a second service list 233 that includes items that are different from the first service list 233. In some instances, the second service lists 233 can compare the first service lists 233 for the payment instrument 106 to the second service lists 233 for the supplemental payment instrument 109.

In some scenarios, the first service list 233 and the second service list 233 can include items in the same category (e.g., both lists offer rewards for the same purchase types). In these scenarios, the configuration service 212 can compare and identify the higher or better service offered between the first service list 233 and the second service list 233. For example, the configuration service 212 can identify that the supplemental payment instrument 109 offers a higher rewards service for “other purchases” (e.g., double reward points for the supplemental payment instrument 109 compared to one point for every dollar in a purchase transaction for the payment instrument 106).

The second portion 306 can include an add component 312 and an additional charge fee 315. The add component 312 can be selected by the user to add new services offered by the supplemental payment instrument 109 to the payment instrument 106. The additional charge fee 315 can represent a fee for adding the new services to the payment instrument 106. In some scenarios, the supplemental payment instrument 109 in a stand-alone scenario may charge customers a default annual fee. By adding the limited set of services from the supplemental payment instrument 109 that are shown, the user can be offered a lower annual fee than the default amount. As such, the user is able to make use of some items from the second service list for the supplemental payment instrument 109 without having to pay the full annual fee typically required for the supplemental payment instrument 109.

In addition, the additional charge fee 315 can be determined based on a change from an initial services configuration 227. For example, the additional charge fee 315 can be based on a weightage-based rule associated with the change in the services configuration. The weightage-based rule can include parameters for identifying a cost to apply to particular services that have been added to the services configuration. The weightage-based rule can be retrieved from the payment instrument data 221.

In some examples, the configuration service 212 can be configured to identify the added services (e.g., the change of services) by comparing the hybrid list of services to a prior list of services (e.g., a default services configuration or a previous services configuration, etc.). After the added services have been identified, then the configuration services 212 can determine a weightage-based rule to apply from the payment instrument data 221. The weightage-based rule can include a cost associated with one or more of the added services.

The third portion 309 can include a third service list (e.g., a hybrid list of services) in which some of the items from the second service list are added to the first service list for the payment instrument 106. Additionally, the third service list can also include a minimum enrollment time period (e.g., 90 days). The minimum enrollment time period can represent a period of time in which the user has to maintain the added services of the supplemental payment instrument 109. Accordingly, the user cannot remove the added services of the supplemental payment instrument 109 until the minimum enrollment time period has expired from the enrolment of the added services for the supplemental payment instrument 109.

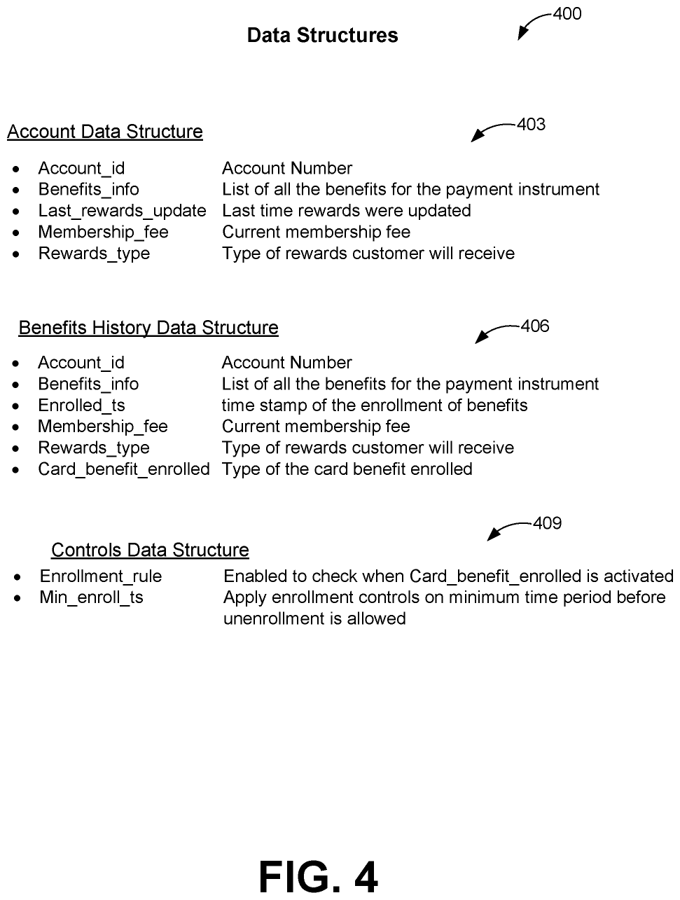

Turning now to FIG. 4, shown are example data structures 400 that can be implemented as portions of the computing environment 203. These data structures 400 can be used to configure and modify the services configuration 227 for the payment instrument 106. The data structures 400 can be stored in the data store 215. These data structures can be an improved format for processing, organizing, storing, and retrieving data from the data store 215. For instance, the improved format can enable a customized hybrid list of services to be stored and retrieved for a payment instrument 106. Accordingly, a first user and a second user can each own their payment instrument 106 (e.g., Travel Credit Card) from a financial institution, and each payment instrument 106 can have a unique set of services that are applied for transactions.

The data structures 400 can be implemented in various manners. For example, the data structures 400 can be as an array of values, a linked listed, a list, a tree, a map, and other suitable data structures 400.

Data elements in these data structures 400 can be updated based at least in part on selections made on one or more user interface 242 (e.g., services user interface 103, the user interface 242, etc.). As new data elements are received from the user interface 242, the data structures 400 can be updated at the data store 215. The data structures 400 can include an account data structure 403, a benefits history data structure 406, a controls data structure 409, and other suitable data structures.

The account data structure 403 can include data elements such as an account number (e.g., a user identifier 224, a payment instrument identifier, etc.), a list of all benefits and services (e.g., a services configuration 227) for a payment instrument 106, a time stamp for the last time the rewards were updated (e.g., a user profile 218, payment instrument data 221), a current membership fee (e.g., a user profile 218, payment instrument data 221), a rewards type for the user (e.g., a user profile 218, payment instrument data 221), and other suitable data elements.

The benefits history data structure 406 can include data elements such as an account number (e.g., a user identifier 224, a payment instrument identifier, etc.), a list of all benefits and services (e.g., a services configuration 227) for a payment instrument 106, a time stamp for a point in time for the enrollment in the list of benefits (e.g., a user profile 218, payment instrument data 221), a current membership fee (e.g., a user profile 218, payment instrument data 221), a rewards type for the user (e.g., a user profile 218, payment instrument data 221), a card type of the card benefits enrolled (e.g., a user profile 218, payment instrument data 221), and other suitable data elements.

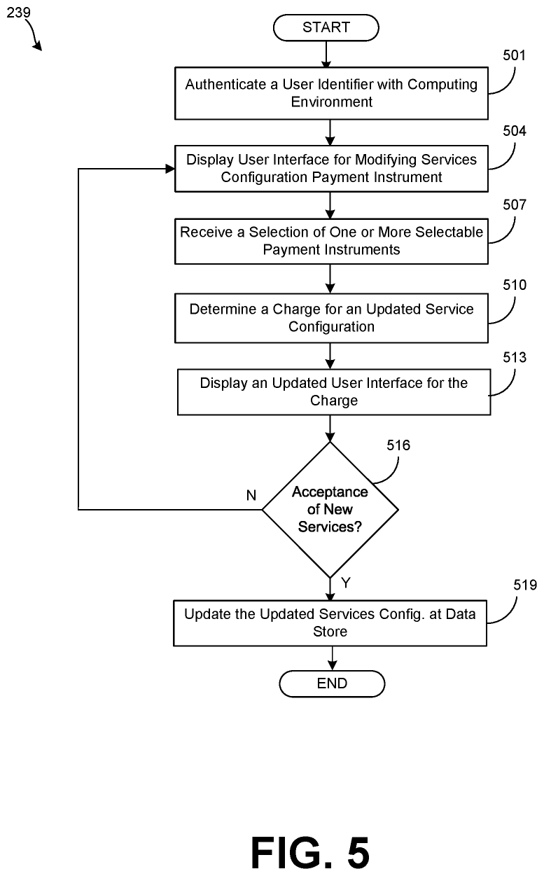

Referring next to FIG. 5, shown is a flowchart that provides one example of the operation of a portion of the client application 239. The flowchart of FIG. 5 provides merely an example of the many different types of functional arrangements that can be employed to implement the operation of the depicted portion of the client application 239. As an alternative, the flowchart of FIG. 5 can be viewed as depicting an example of elements of a method implemented within the network environment 200.

Beginning with block 501, the client application 239 can authenticate a user identifier 224 with the computing environment 203. The user may desire to modify services available to their payment instrument 106. The user can submit a credential 238 to a login user interface displayed on the client device 206. In some instances, the client application 239 can transmit the submitted credential 238 to the configuration service 212 to authenticate the user. After the user has been authenticated, the client application 239 can identify the user profile 218 and one or more payment instruments 106 associated with the credentials 238. In some instances, the user can select a user interface element for modifying services (e.g., a services configuration 227) for the payment instrument 106.

In block 504, the client application 239 can display a services user interface 103 for modifying the services configuration 227 for the payment instrument 106. The services user interface 103 can include an array of supplemental payment instruments 109 for the user to select among. In some examples, the services user interface 103 can include a service list 233 for each supplemental payment instrument 109, which can describe the unique services that are available for each supplemental payment instrument 109. Each supplemental payment instrument 109 can be selectable by way of an image of the supplemental payment instrument 109 or a user interface element 112 associated with each supplemental payment instrument 109.

In some examples, the supplemental payment instruments 109 that are displayed on the services user interface 103 can be determined based at least in part on one or more factors. For instance, the location of the client device 206 can be used to identify which supplemental payment instruments 109 are available to the user. The location can be determined by a sensor 236 (e.g., a GPS device), from stored location data in the user profile 218, and other location detection techniques.

In block 507, the client application 239 can receive a selection of one or more supplemental payment instruments 109 from the user interface 242. The client application 239 can determine a payment instrument identifier for each selected supplemental payment instrument 109, and in some embodiments, the client application 239 can transmit the payment instrument identifiers for all of the selected supplemental payment instruments 109.

In block 510, the client application 239 can determine a charge fee for an updated services configuration 227. The charge fee can be determined based at least in part on the payment instrument 106 being available to have a combination of a first set of services from the payment instrument 106 and a second set of services from one or more supplemental payment instruments 109. In some embodiments, the client application 239 can receive the charge fee from the configuration service 212 using one or more data structures 400 (e.g., account data structure 403, the benefits history data structure 406, the controls data structure 409, and/or other suitable data structures). The data structures 400 can be used for improved data communication between communication between the client device 206 and the computing environment 203.

In other embodiments, the client application 239 can determine the charge fee based at least in part on the payment instrument data 221 and other pricing models received from the configuration service 212. The client application 239 can use the pricing model to determine the charge fee based at least in part on a base payment instrument and added services from the supplemental payment instrument 109.

In block 513, the client application 239 can display an user interface 242 that has been updated on the client device 206. The updated user interface 242 can display a first set of services for the payment instrument 106 and a second set of services for the selected supplemental payment instrument 109. The updated user interface 242 can include an add component 312 and the charge fee 315.

In block 516, the client application 239 can determine whether an acceptance of the updated services configuration 227 has been received. The acceptance can also be related to an acceptance of the charge fee. The client application 239 can identify the acceptance based at least in part on identifying a selection of a user interface element (e.g., the add component 312). Upon the acceptance, the client application 239 can identify an updated services configuration 227 from the hybrid of services offered to the payment instrument 106 and the supplemental payment instrument 109. If the user has accepted the updated services configuration 227, then the client application 239 can proceed to block 519. If the user has not accepted the updated services configuration 227, then the client application 239 can proceed back to block 504.

In block 519, the client application 239 can store the updated services configuration 227 in the data store 215. The client application 239 can transmit the updated services configuration 227 to the configuration service 212 for storage in the data store 215.

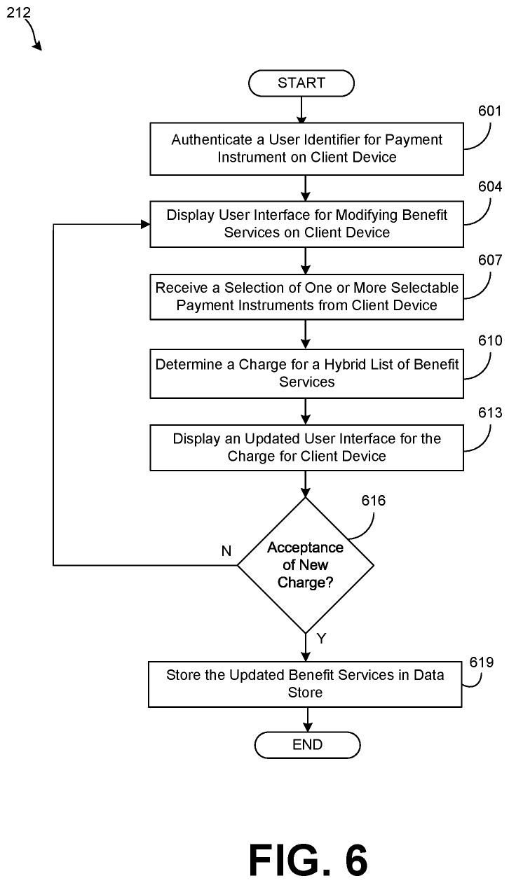

Referring next to FIG. 6, shown is a flowchart that provides one example of the operation of a portion of the configuration service 212. The flowchart of FIG. 6 provides merely an example of the many different types of functional arrangements that can be employed to implement the operation of the depicted portion of the configuration service 212. As an alternative, the flowchart of FIG. 6 can be viewed as depicting an example of elements of a method implemented within the network environment 200.

Beginning with block 601, the configuration service 212 can authenticate a user identifier for a payment instrument 106 on the client device 206. The user may desire to modify services available to their payment instrument 106. The configuration service 212 can receive an authenticate request from the client device 206 and can authentication a user identifier 224 based at least in part on the authentication request. In some embodiments, the authentication request can include a credential 238 that was provided to a login user interface. After the user has been authenticated, the configuration service 212 can identify the user profile 218 and one or more payment instruments 106 associated with the credentials 238. In some instances, the user can select a user interface element 112 for modifying services (e.g., a services configuration 227) for the payment instrument 106.

In block 604, the configuration service 212 can display a services user interface 103 for modifying the services configuration 227 for the payment instrument 106 on the client device 206. The services user interface 103 can include an array of supplemental payment instruments 109 for the user to select among. In some examples, the services user interface 103 can include a service list 233 for each supplemental payment instrument 109, which can describe the unique services that are available for each supplemental payment instrument 109. Each supplemental payment instrument 109 can be selectable by way of an image of the supplemental payment instrument 109 or a user interface element 112 associated with each supplemental payment instrument 109.

In some examples, the supplemental payment instruments 109 that are displayed on the services user interface 103 can be determined based at least in part on one or more factors. For instance, the location of the client device 206 can be used to identify which supplemental payment instruments 109 are available to the user. The location can be determined by a sensor 236 (e.g., a GPS device), from stored location data in the user profile 218, and other location-based techniques.

In block 607, the configuration service 212 can receive a selection of one or more supplemental payment instruments 109 from the client application 239. The selection can include one more supplemental payment instruments 109. The configuration service 212 can determine a payment instrument identifier for each selected supplemental payment instrument 109.

In block 610, the configuration service 212 can determine a charge fee for an updated services configuration 227. The charge fee can be determined based at least in part on the payment instrument 106 being available to have a combination of a first set of services from the payment instrument 106 and a second set of services from one or more supplemental payment instruments 109. In some embodiments, the configuration service 212 can transmit the charge fee to the client application 239 for display in the user interface 242.

The configuration service 212 can determine the charge fee by providing a first set of services for the payment instrument and a second set of services for a supplemental payment instrument 109 to a pricing model. In some examples, the pricing model can be implemented using a machine learning model for price optimization and/or predictive pricing. The machine learning models such as a regression model, Long Short Term Memory Network (LSTMN), a time series model, a generalized linear model, and other suitable machine learning models that can be implemented for dynamic pricing. In some non-limiting examples, the machine learning models can evaluate variables, such as a level of demand for a supplemental payment instrument, a quantity of services being offered, a location of the user, a payment instrument type, a rewards type for the payment instrument 106, or other suitable variables.

In block 613, the configuration service 212 can display an user interface 242 that has been updated on the client device 206. The updated user interface 242 can display a first set of services for the payment instrument 106 and a second set of services for the selected supplemental payment instrument 109. The updated user interface 242 can include an add component 312 and the charge fee 315.

In block 616, the configuration service 212 can determine whether an acceptance of the updated services configuration 227 has been received. The acceptance can also be related to an acceptance of the charge fee 315. The configuration service 212 can receive an indication of the acceptance from the client application 239 based at least in part on identifying a selection of a user interface element (e.g., the add component 312). Upon the acceptance, the configuration service 212 can identify an updated services configuration 227 from the hybrid of services offered to the payment instrument 106 and the supplemental payment instrument 109. If the user has accepted the updated services configuration 227, then the configuration service 212 can proceed to block 619. If the user has not accepted the updated services configuration, then the configuration service 212 can proceed back to block 604.

In block 619, the configuration service 212 can store the updated services configuration 227 in the data store 215. In some non-limiting examples, the configuration service 212 can use one or more data structures 400, such has the account data structure 403, the benefits history data structure 406, the controls data structure 409 and/or other suitable data structure, in order to store the updated services configuration 227 in the data store 215. Then, the configuration service 212 can proceed to the end.

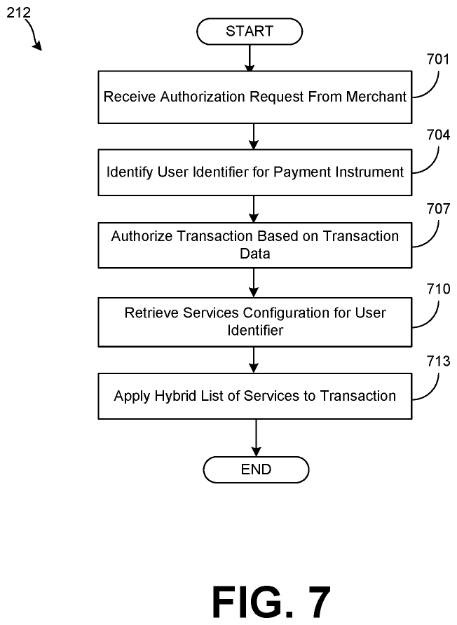

Referring next to FIG. 7, shown is a flowchart that provides one example of the operation of a portion of the configuration service 212. The flowchart of FIG. 7 provides merely an example of the many different types of functional arrangements that can be employed to implement the operation of the depicted portion of the configuration service 212. As an alternative, the flowchart of FIG. 7 can be viewed as depicting an example of the elements of a method implemented within the network environment 200.

Beginning with block 701, the configuration service 212 can receive an authorization request for a transaction from a merchant. The authorization request can include an identifier for the payment instrument 106 (e.g., a credit card number, a debit card number, a rewards car number, etc.), the user identifier 224 (e.g., an account number), and/or other suitable identifiers. The authorization request can include transaction data, such as the transaction time stamp, transaction amount, merchant identifier, merchant type, and other suitable data.

In block 704, the configuration service 212 can identify the user from the authorization request. The authorization request can include the user identifier 224, a payment instrument identifier, or other unique identifiers. The authorization request can include transaction data, such as merchant type, merchant name, transaction amount, transaction type, time stamp for transaction, transaction location, and other transaction related data.

In block 707, the configuration service 212 can authorize the authorization request of the transaction based at least in part on the transaction data. The configuration services 212 can execute one or more payment authorization services, as such account services, fraud monitoring services, and other transaction related services. For example, the configuration service 212 can determine whether there are insufficient funds in the account, whether the credit limit has been exceeded, and other related account services.

In block 710, the configuration service 212 can retrieve a services configuration 227, which may be a hybrid list of services from a first payment instrument 106 and a supplemental payment instrument 109. The configuration service 212 can retrieve the services configuration 227 in a data format (e.g., FIG. 4 (400)) that allows for the user to modify the services configuration 227 dynamically. The hybrid list of services can include a combination of a first set of services from the existing payment instrument 106 and a second set of services from the supplemental payment instrument 109.

In block 713, the configuration service 212 can apply the services configuration 227 to the transaction. For example, if the services configuration 227 has been modified. In the event that the configuration services 212 has been modified from a default list of services for the payment instrument 106, then the services configuration 227 has a list of all of the services that can be applied to the transaction. For instance, the modified services configuration 227 can be a hybrid list of services, which include a first set of services from the payment instrument 106 and a second set of services from a selected supplemental payment instrument 109. As such, the configuration service 212 can use the modified services configuration 227 to know which services to apply to the transaction. Then, the configuration service 212 proceeds to the end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 5-7 show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts of FIGS. 5-7 show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts of FIGS. 5-7 can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same network environment 200.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
display a user interface that is configured to modify a services configuration for a payment instrument associated with a user identifier, the services configuration indicating a plurality of benefit services that are applied to a respective transaction;
receive a modification of the services configuration from the user interface;
display an updated user interface that includes a charge for the services configuration based at least in part on the modification of the services configuration;
receive an acceptance of the charge from the updated user interface; and
update the services configuration by storing the services configuration in association with the user identifier at a database based at least in part on the acceptance of the charge.

2. The system of claim 1, wherein the machine-readable instructions stored in the memory that, when executed by the processor, cause the computing device to at least:
identify the user identifier of the payment instrument based at least in part on authenticating a credential received from the user interface with a remote computing device.

3. The system of claim 1, wherein the machine-readable instructions further cause the computing device to at least:
generate a hybrid list of services by comparing a first list of benefit parameters for a first payment instrument to a second list of benefit parameters for a second payment instrument.

4. The system of claim 3, wherein the hybrid list of services comprises a higher benefit parameter for each category from a comparison of the first list of benefit parameters and the second list of benefit parameters.

5. The system of claim 4, wherein the updated user interface displays the hybrid list of services and includes an indicator to highlight the higher benefit parameter originated from the first list of benefit parameters or the second list of benefit parameters.

6. The system of claim 1, wherein the payment instrument is a first payment instrument, and displaying the updated user interface further causes the computing device to at least:
determine the charge for the modification of the services configuration based at least in part on a change in the services configuration from an initial services configuration and a weightage-based rule associated with the change in the services configuration.

7. The system of claim 6, wherein the change in the services configuration is determined by comparing the initial services configuration for the payment instrument to an updated services configuration for the payment instrument.

8. A method, comprising:
displaying, by a client device, a user interface that is configured to modify a services configuration for a payment instrument associated with a user identifier, the services configuration indicating a plurality of benefit services that are applied to a respective transaction;
receiving, by the client device, a modification of the services configuration from the user interface;
displaying, by the client device, an updated user interface that includes a charge for the services configuration based at least in part on the modification of the services configuration;
receiving, by the client device, an acceptance of the charge from the updated user interface; and
updating, by the client device, the services configuration by storing the services configuration in association with the user identifier at a database based at least in part on the acceptance of the charge.

9. The method of claim 8, further comprising:
identifying, by the client device, the user identifier of the payment instrument based at least in part on authenticating a credential received from the user interface.

10. The method of claim 8, further comprising:
generating, by the client device, a hybrid list of services by comparing a first list of benefit parameters for a first payment instrument to a second list of benefit parameters for a second payment instrument.

11. The method of claim 10, wherein the hybrid list of services comprises a higher benefit parameter for each category from a comparison of the first list of benefit parameters and the second list of benefit parameters.

12. The method of claim 11, wherein the updated user interface displays the hybrid list of services and includes an indicator to highlight the higher benefit parameter originated from the first list of benefit parameters or the second list of benefit parameters.

13. The method of claim 8, wherein the payment instrument is a first payment instrument, and displaying the updated user interface further comprising:
determining, by the client device, the charge for the modification of the services configuration based at least in part on a change in the services configuration from an initial services configuration and a weightage-based rule associated with the change in the services configuration.

14. The method of claim 13, wherein the change in the services configuration is determined by comparing the initial services configuration for the payment instrument to an updated services configuration for the payment instrument.

15. The method of claim 8, wherein the user interface includes an indicator for the payment instrument, and the user interface comprises an array of selectable payment instruments.

16. A system, comprising:
a computing device comprising a processor and a memory; and
machine-readable instructions stored in the memory that, when executed by the processor, cause the computing device to at least:
receive an authorization request for a transaction at a merchant, the authorization request comprising a payment instrument identifier for a payment instrument and transaction data;
identify a user identifier for the payment instrument identifier;
authorize the transaction based at least in part on the transaction data;
retrieve a hybrid list of services for the user identifier from a database, the hybrid list of services comprises a combination of benefits from a first payment instrument and a second payment instrument; and
apply the hybrid list of services to the transaction based at least in part on the authorization of the transaction.

17. The system of claim 16, wherein the machine-readable instructions, when executed by the processor, cause the computing device to at least:
identify the user identifier of the payment instrument based at least in part on authenticating a credential received from a user interface displayed on a client device; and
update the user interface on the client device to include an array of selectable payment instruments for modifying the hybrid list of services for the payment instrument.

18. The system of claim 17, wherein the machine-readable instructions, when executed by the processor, cause the computing device to at least:
receive a selected payment instrument from the user interface displayed on the client device; and
display in the user interface the hybrid list of services by comparing the selectable payment instruments and the payment instrument.

19. The system of claim 18, wherein the hybrid list of services comprises a higher benefit parameter for each category from a comparison of a first list of benefit parameters and a second list of benefit parameters.

20. The system of claim 17, wherein the machine-readable instructions, when executed by the processor, cause the computing device to at least:
receive a selected payment instrument from the user interface displayed on the client device; and
determine a charge for the hybrid list of services based at least in part on a difference between the selected payment instrument and the payment instrument and a weighted rate associated with the difference between the selected payment instrument and the payment instrument.
